(19) United States
(12) Patent Application Publication
(10) Pub. No.: US 2003/0215696 A1
(43) Pub. Date: Nov. 20, 2003

(54) Electrode catalysts for H2S fuel cell

(76) Inventors: Karl T. Chuang, Edmonton (CA); Jingli Luo, Edmonton (CA); Guolin Wei, Edmonton (CA); Alan R. Sanger, Edmonton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/143,944

(22) Filed: May 14, 2002

(51) Int. Cl. H01M 4/86; H01M 4/88

(52) U.S. Cl. 429/40; 429/44; 502/101; 204/280

(57) ABSTRACT

The present invention relates to an anode catalyst for use in the electrochemical oxidation of H₂S to elemental sulfur, protons and electrons, specifically in a fuel cell having a proton-conducting membrane. The catalyst comprises two or more metal sulfides of the formula MSₓ, wherein M is selected from the group consisting of Co, Ni, Fe, Mo, Cu, Cr, W and Mn, and x is between about 1.0 and about 2.5; a conductive material suitable for fuel cell operation; and a porous material. The invention further provides methods of preparing the catalyst, fuel cells comprising the catalyst and methods of electrochemically oxidizing H₂S using the catalyst.

### FIELD OF THE INVENTION

The present invention relates to catalysts for solid oxide fuel cells, specifically for the co-generation of elemental sulfur and electrical power from hydrogen sulfide.

### BACKGROUND OF THE INVENTION

A majority of fuel cell systems developed to date use hydrogen and oxygen as anode and cathode feed respectively. Although hydrogen has a high energy density, a variety of alternative fuels have been investigated as fuels for transportation fuel cell systems, as they are safer to store and transport. In particular, methanol is the subject of several investigations (Kordesch and Simader, 1996, p. 151). Ammonia or hydrazine each has high power density, but requires safe handling (Kordesch and Simader, 1996, p. 333). Methanol or hydrocarbon fuels can be re-formed to hydrogen for use in standing or mobile power units (Kordesch and Simader, 1996, p. 297; Ziaka and Vasileiadis, 2000; Nakagaki et al., 2000). In each of these cases, the fuel is totally consumed for generation of hydrogen, that is then used to generate electrical power, and all carbon is converted to C0₂.

In principle, the free energy change for any chemical reaction can be converted to electrical energy in a proton conducting fuel cell (Eq. 1-3), if the required characteristics are present. A similar set of equations can be drawn for a solid oxide fuel cell (SOFC). In each case, suitable anode and cathode materials must be used to catalyze reactions 1 and 2. Partial oxidation of XH² to X thereby provides free energy recoverable as electrical power.

| | | |
|---|---|---|
| 1. | anode | XH₂ → X + 2H⁺ + 2 e⁻ |
| 2. | cathode | O₂ + 4H⁺ + 4 e⁻ → 2H₂O |
| 3. | overall | 2XH₂ (fuel) + O₂ → X (product) + 2H₂O |

Any reaction in which a fuel (XH₂ in Eq.1) is oxidized to a value-added product (X) and energy, is a potential candidate for application in a fuel cell for co-generation of chemicals and power. One example of such a process is the production of sulfur from hydrogen sulfide.

Potential benefits from use of fuel cell technology for production of chemicals include improved selectivity and efficiency. An economic advantage is that there is a negative cost of feed for production of electrical power, as the cost of fuel is more than offset by the value of the product. In the case of conversion of H₂S, the value of sulfur is not great. However, in this case use of a fuel cell-based process offers the potential economic advantage of reduced cost of treatment of sour gas streams. For other systems, for example when hydrocarbons are converted to products of significantly higher value, reduced cost for manufacturing the product can provide an economic incentive (Mazanec and Cable, 1990; Michaels and Vayenas, 1984; Petrovic et al., 2001; White et al., 2001).

H₂S is a toxic and highly reactive pollutant. Removal of H₂S from natural gas and process streams is costly. The energy generated by oxidation of H₂S to either sulfur, as in the Claus process, or SOₓ by combustion, is either vented or partly recovered as low-grade heat (Chuang and Sanger, 2000). There is a clear economic benefit to recovery of the heat of reaction of H₂S to elemental sulfur as high-grade electrical energy.

Experimental SOFC's are known in which hydrogen sulfide can be oxidized; however no catalysts have yet been developed that are sufficiently active for fuel cell applications. In fact there are, at present, no commercial fuel cells for the production of sulfur from hydrogen sulfide.

### SUMMARY OF THE INVENTION

The present inventors have shown that admixing a suitable conductive material, such as metallic silver (Ag), with a metal sulfide-based anode catalyst and then mixing this composite anode catalyst with about 5% of a porous material, such as yttria-stabilized zirconia (YSZ), provides a composite anode catalyst which significantly improves performance of an H₂S—O₂ fuel cell having a proton conducting membrane.

Accordingly, the present invention relates to an anode catalyst composition for a gas phase H₂S—O₂ fuel cell having a proton-conducting membrane comprising:

(a) two or more metal sulfides of the formula MSₓ, wherein M is selected from the group consisting of Co, Ni, Fe, Mo, Cu, Cr, W and Mn, and x is between about 1.0 and about 2.5;

(b) a conductive material suitable for fuel cell operation; and

(c) a porous material,

wherein both (b) and (c) are present in the composition in amounts up to about 10% by weight of the composition. A preferred ratio of (a):(b):(c) is about 90:5:5.

In a further aspect of the present invention there is provided a method of preparing an anode catalyst composition for a gas phase H₂S—O₂ fuel cell having a proton-conducting membrane comprising:

(a) combining two or more metal sulfides of the formula MSₓ, wherein M is selected from the group consisting of Co, Ni, Fe, Mo, Cu, Cr, W and Mn and x is between about 1.0 and about 2.5, with a conductive material suitable for fuel cell operation; and

(b) combining the combination of (a) with a porous material,

wherein both of the conductive material and porous material are present in the composition in amounts up to about 10% by weight of the composition.

The present invention further relates to an electrolysis cell for the gas phase electrochemical oxidation of H₂S to sulfur and water or hydrogen comprising an anode chamber on one side of a proton-conducting membrane and a cathode chamber on the opposing side of the proton-conducting membrane, said anode chamber having an catalytic anode and said cathode chamber having a catalytic cathode wherein said anode comprises a catalyst as defined above.

There is further provided a process for the gas phase electrochemical oxidation of H₂S to sulfur and water or hydrogen using an electrolysis cell having an anode chamber on one side of a solid proton conducting membrane and a cathode chamber on the opposing side of the membrane comprising the steps of:

(1) passing an H₂S-containing gas through the anode chamber to contact a catalytic anode, where it reacts to produce elemental sulfur, protons and electrons;

(2) passing protons through the membrane from the anode chamber to the cathode chamber; and

(3) either passing an oxygen-containing gas through the cathode chamber to contact the catalytic cathode, where it reacts with protons and electrons to produce water or steam, or forming hydrogen in the cathode chamber,

wherein said catalytic anode comprises a catalyst as defined above.

The present invention satisfies the need for an active and long-lived anode catalyst for H₂S/O₂ fuel cells. The anode catalyst of the present invention is stable enough to be used at temperatures that allow the formation of sulfur vapour at the catalyst sites, avoiding formation of liquid sulfur at the surface and consequent blockage of access to catalytic sites, thereby leading to higher long term efficiency.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will now be described in relation to the drawings in which:

FIG. 1 is a graph of voltage as a function of current density for a fuel cell uitlizing the anode catalyst of Example 1.

FIG. 2 is a graph of power density versus current density for a fuel cell uitlizing the anode catalyst of Example 1.

FIG. 3 is a graph of voltage as a function of current density for a fuel cell uitlizing the anode catalyst of Example 2.

FIG. 4 is a graph of power density versus current density for a fuel cell uitlizing the anode catalyst of Example 2.

FIG. 5 is a graph of voltage as a function of current density for a fuel cell uitlizing the anode catalyst of Example 3.

FIG. 6 is a graph of power density versus current density for a fuel cell uitlizing the anode catalyst of Example 3.

FIG. 7 is a graph of voltage as a function of current density for a fuel cell uitlizing the anode catalyst of Example 4.

FIG. 8 is a graph of power density versus current density for a fuel cell uitlizing the anode catalyst of Example 4.

FIG. 9 is a graph of voltage as a function of current density for a fuel cell uitlizing the anode catalyst of Example 5.

FIG. 10 is a graph of power density versus current density for a fuel cell uitlizing the anode catalyst of Example 5.

### DETAILED DESCRIPTION OF THE INVENTION

The present inventors have performed systematic research on the development of optimum anode catalyst designs for gas phase H₂S—O₂ fuel cells having proton-conducting membranes. It has been found that by admixing a suitable conductive material, such as metallic silver (Ag), with a mixed-metal sulfide-based anode catalyst, and then mixing this composite anode catalyst with about 5% of a porous material, such as yttria-stabilized zirconia (YSZ), significant improvements in the performance of an H₂S—O₂ fuel cell can be achieved.

Accordingly, the present invention relates to an anode catalyst composition for a gas phase H₂S—O₂ fuel cell having a proton-conducting membrane comprising:

(a) two or more metal sulfides of the formula MSₓ, wherein M is selected from the group consisting of Co, Ni, Fe, Mo, Cu, Cr, W and Mn, and x is between about 1.0 and about 2.5;

(b) a conductive material suitable for fuel cell operation; and

(c) a porous material,

wherein both of the conductive material and porous material are present in the composition in amounts up to about 10% by weight of the composition.

As stated above, the anode catalyst comprises a mixed metal sulfide comprising two or more metal sulfides of the formula MSₓ, wherein M is selected from the group consisting of Co, Ni, Fe, Mo, Cu, Cr, W and Mn, and x is between about 1.0 and about 2.5. In embodiments of the present invention, M is selected from the group consisting of Co, Ni, Fe, Mo, W and Mn. In a further embodiment of the present invention, the anode catalyst comprises two metal sulfides of the formula MSₓ wherein M is selected from the group consisting of Co, Ni, Fe, Mo, Cu, Cr, W and Mn, and x is between about 1.0 and about 2.5. In a specific embodiment, the anode catalyst comprises two metal sulfides, with one metal sulfide having M selected from the group consisting of Co, Ni and Fe and the second metal sulfide having M selected from the group consisting of Mo and W. In another embodiment of the present invention, the catalyst comprises NiS and MoS₂.

The mixed metal sulfide may be prepared by combining two or more metal sulfides, preferably in approximately equivalent amounts by weight. It will be recognized that the mixed metal sulfide may be formed by partially or completely sulfiding corresponding mixed metal oxides or similar compounds.

The conductive material may be any such material that is stable under the operating conditions required for the gas phase electrochemical oxidation of H₂S. Examples of metals and metal oxides useful as a conductive material would be well known to those skilled in the art and include silver, gold, nickel, bismuth, manganese, vanadium, platinum, rhodium, ruthenium, palladium, copper, zinc, cobalt, chromium, and iron metals and metal oxides, any mixtures of said metals and metal oxides, and other mixtures such as silver-bismuth oxide mixtures, tin-indium oxide mixtures, praeseodymium-indium oxide mixtures, cerium-lanthanum oxide mixtures, etc., and mixtures thereof. Among these, silver is preferred.

The porous material may be any such material that does not interfere with the reaction process. Examples of porous materials are well known in the art and include any of a large number of oxides, including yttria-stabilized zirconia (YSZ), doped ceria, thoria-based materials, or doped bismuth oxides and various other metal oxides. Specific examples include, but are not limited to CaO-stabilized ZrO₂; Y₂O₃-stabilized ZrO₂; Sc₂O₃-stabilized ZrO₂; Y₂O₃-stabilized Bi₂O₃; Y₂O₃-stabilized CeO₂; CaO-stabilized CeO₂; ThO₂; Y₂O₃-stabilized ThO₂; ThO₂, ZrO₂, Bi₂O, CeO₂ or HfO₂ stabilized by the addition of any one of the lanthanide oxides or CaO; and Al₂O₃. A preferred porous material is yttria-stabilized zirconia (YSZ).

The amount of both of the conductive material and the porous material in the anode catalyst composition of the present invention may be up to about 10% by weight of the final composition. In embodiments of the invention the ratio of metal sulfide:conductive material:porous material in the anode catalyst composition of the present invention is about 90:5:5, more specifically, about 90.25:4.75:5. Unless otherwise stated, all ratios and percentages described herein are based on weight.

In an embodiment of the present invention, the anode catalyst composition is prepared by first combining the metal sulfides and then combining the mixed metal sulfides with the conducting material to provide a composite anode catalyst. This composite metal catalyst is then combined with the porous material.

Accordingly, there is provided a method of preparing an anode catalyst composition for a gas phase H₂S—O₂ fuel cell having a proton-conducting membrane comprising:

(a) combining two or more metal sulfides of the formula MSₓ, wherein M is selected from the group consisting of Co, Ni, Fe, Mo, Cu, Cr, W and Mn and x is between about 1.0 and about 2.5, with a conductive material suitable for fuel cell operation; and

(b) combining the combination of (a) with a porous material,

wherein both of the conductive material and porous material are present in the composition in amounts up to about 10% by weight of the composition.

The present invention further relates to an electrolysis cell for the gas phase electrochemical oxidation of H₂S to sulfur and water or hydrogen comprising an anode chamber on one side of a proton-conducting membrane and a cathode chamber on the opposing side of the proton-conducting membrane, said anode chamber having an catalytic anode and said cathode chamber having a catalytic cathode wherein said anode comprises a catalyst comprising:

(a) two or more metal sulfides of the formula MSₓ, wherein M is selected from the group consisting of Co, Ni, Fe, Mo, Cu, Cr, W and Mn, and x is between about 1.0 and about 2.5;

(b) a conductive material suitable for fuel cell operation; and

(c) a porous material,

wherein both of the conductive material and porous material are present in the composition in amounts up to about 10% by weight of the composition.

The present inventors have prepared an example of an anode catalyst according to the invention and have shown that it has significantly improved performance when used in an electrochemical fuel cell for the oxidation of H₂S to sulfur and water. It is also possible to operate the cell in an electrolysis mode to produce sulfur and hydrogen. When operated in electrolysis mode, the gas being fed to the cathode chamber is an inert gas, such as argon or nitrogen, rather than oxygen.

Accordingly, the present invention provides a process for the gas phase electrochemical oxidation of H₂S to sulfur and water or hydrogen using an electrolysis cell having an anode chamber on one side of a solid proton conducting membrane and a cathode chamber on the opposing side of the membrane comprising:

(1) passing an H₂S-containing gas through the anode chamber to contact a catalytic anode, where it reacts to produce elemental sulfur, protons and electrons;

(2) passing protons through the membrane from the anode chamber to the cathode chamber; and

(3) either passing an oxygen-containing gas through the cathode chamber to contact the catalytic cathode, where it reacts with protons and electrons to produce water or steam, or forming hydrogen in the cathode chamber,

wherein said catalytic anode comprises a catalyst comprising

(a) two or more metal sulfides of the formula MSₓ, wherein M is selected from the group consisting of Co, Ni, Fe, Mo, Cu, Cr, W and Mn, and x is between about 1.0 and about 2.5;

(b) a conductive material suitable for fuel cell operation; and

(c) a porous material,

wherein both of the conductive material and porous material are present in the composition in amounts up to about 10% by weight of the composition.

It is known that polymer-based proton-conducting fuel cells utilizing H₂S operating in the temperature range of 120-145° C. produce liquid sulfur and electrical power. Recovery of liquid sulfur from the cells is difficult. If liquid sulfur is allowed to build up within the cell, the operation of the cell is compromised. A cell operating in the sulfur vapour range offers the advantage that sulfur more readily exits the cell, and therefore offers the advantage that operation is not compromised by sulfur build up. When liquid sulfur forms at the anode surface, mass transfer resistance to hydrogen sulfide accessing the catalytic sites is thereby increased, resulting in reduced efficiency.

Accordingly, it has been found that the most effective method of operating the electrolysis cell of the present invention is at temperatures above the vapour point of sulfur, i.e. in the range over 444° C. at one atmosphere pressure, and preferably in the range of about 700° C. to about 1000° C., more preferably in the range of about 750° C. to about 850° C. The following non-limiting examples are illustrative of the present invention:

### EXAMPLES

Materials and Methods

(i) Equipment:

Two types of laboratory fuel cells have been used to study the reactions described herein. In each case the membrane electrode assembly (MEA) has planar geometry. Reactions at atmospheric pressure were performed using a reactor assembly comprising a Pyrex holder for the MEA situated between the anode and cathode chambers. The anode and cathode chambers each had concentric tubes, the inner tube serving as feed tubes and the other tubes serving as tailing gas tubes, as described by Liu et al. (2001). Reactions at elevated pressures were performed in a stainless steel cell substantially similar to that described by Chuang et al. (2001).

(ii) Membranes:

MEA for use at elevated temperatures (up to 900° C.) comprised anode and cathode catalysts screen-printed onto proton-conducting ceramic membranes. The membrane was either yttria-stabilized zirconia (YSZ, 8% Y₂O₃) or YSZ having a sub-micron interlayer of TiO₂ applied as a sol (Kueper et al., 1992) to the anode face of the YSZ membrane before application of platinum paste (Heraeus CL11-5100) as anode catalyst. The MEA so prepared were gradually heated (3° C./min) to 1050° C. (YSZ) or 900° C. (TiO₂/YSZ) and then held at that temperature to remove organics in the paste and to increase adhesion of the electrodes to the membrane.

Platinum meshes were used as anode current collectors and platinum wire was used as cathode current collectors.

(ii) Electrical Measurements:

Open circuit potentials were measured using a Keithly 199 digital multimeter. Potentiodynamic I-V measurements were conducted using a pine AFRED5 potentiostat in conjunction with a VirtualBench data acquisition system. Cell impedence analyses were performed using a Gamry CmS 300/100 impedence measurement system and a Stanford SR810 DSP lock-in amplifier.

(iv) Gas analyses:

The composition of feed and effluent gas streams was monitored using one or both of FTIR (10 cm path length gas cell) and GC (Hewlett Packard Model 5890 GC, molecular sieve column and TCD, with a HP 3396 Series II integrator).

(v) Materials:

Anode feed gases were hydrogen sulfide (CP grade) or 5% H₂S/N₂, and cathode feed was either oxygen or air, each supplied as compressed gases (Praxair).

### Example 1

MoS₂ as Anode Catalyst

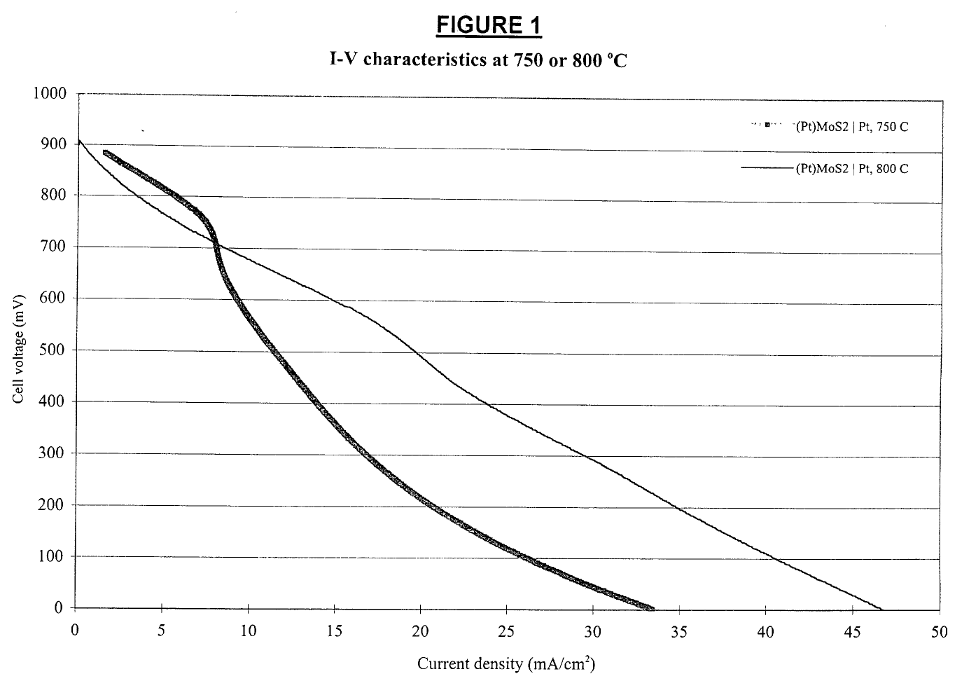

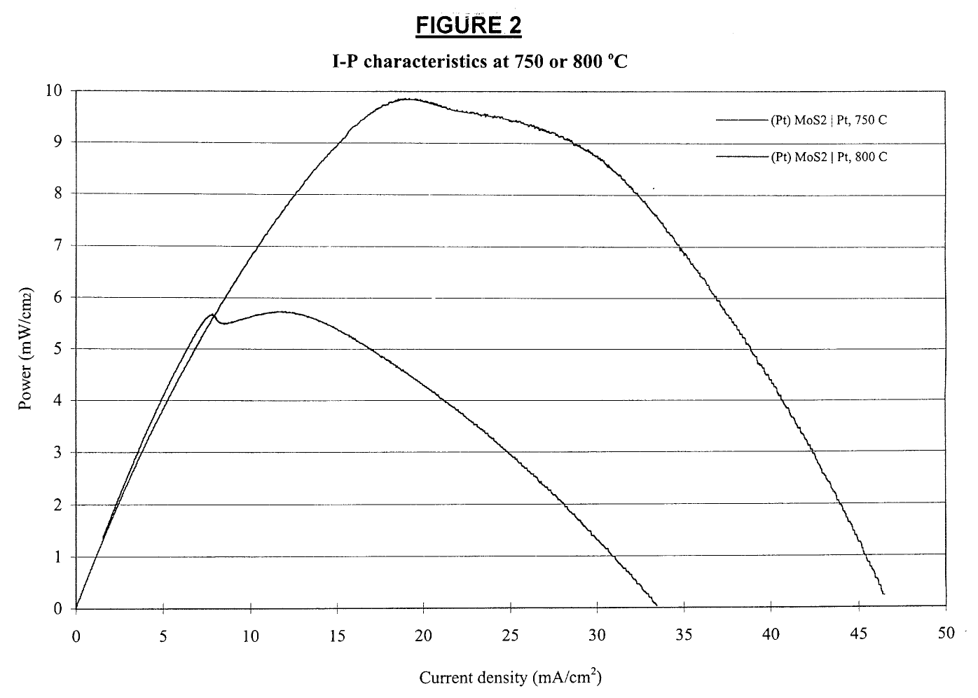

MoSₛ was mixed with α-terpeniol to make a paste. The paste was applied to a YSZ disk. A layer of platinum paste was applied onto the anode to enhance electric contact. A graph of voltage as a function of current density for a fuel cell having this anode catalyst is shown in FIG. 1. A graph of power density versus current density is shown in FIG. 2.

### Example 2

MoS₂+Ag as Anode Catalyst

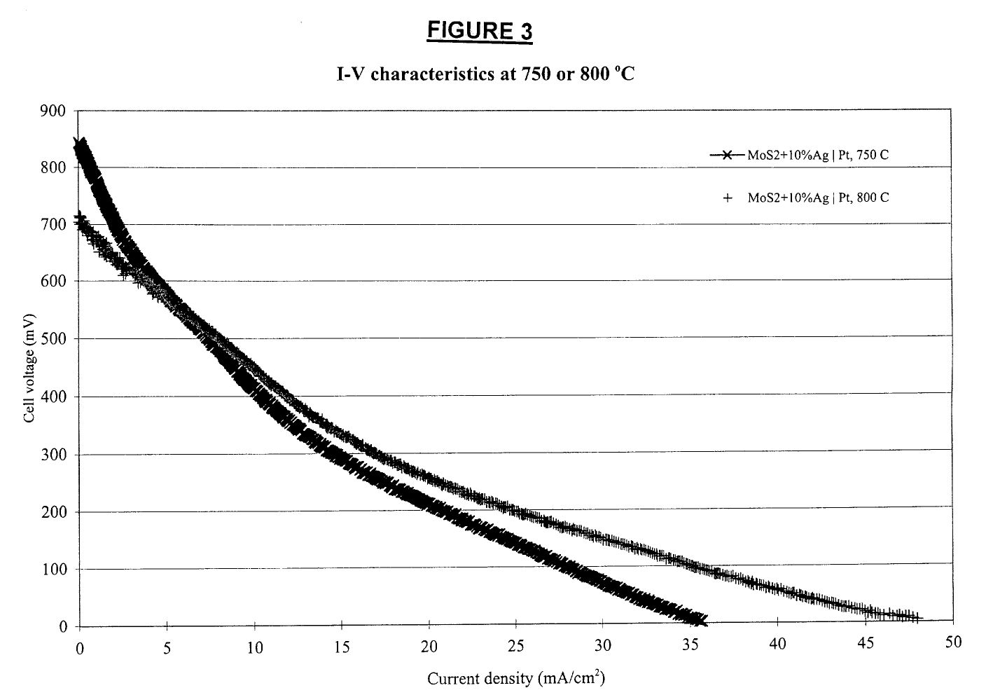

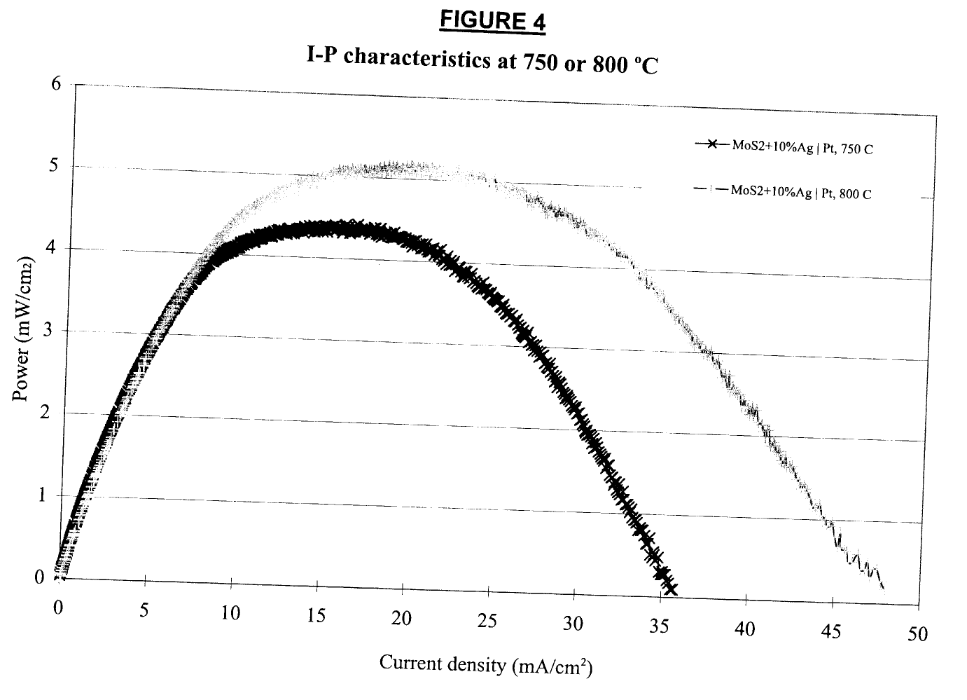

MOS₂ and Ag (95:5 by weight) were combined and mixed with α-terpeniol to make a paste. A layer of platinum paste was applied onto the anode to enhance electric contact. A graph of voltage as a function of current density for a fuel cell having this anode catalyst is shown in FIG. 3. A graph of power density versus current density is shown in FIG. 4.

### Example 3

(MOS₂+Ag)+YSZ as Anode Catalyst

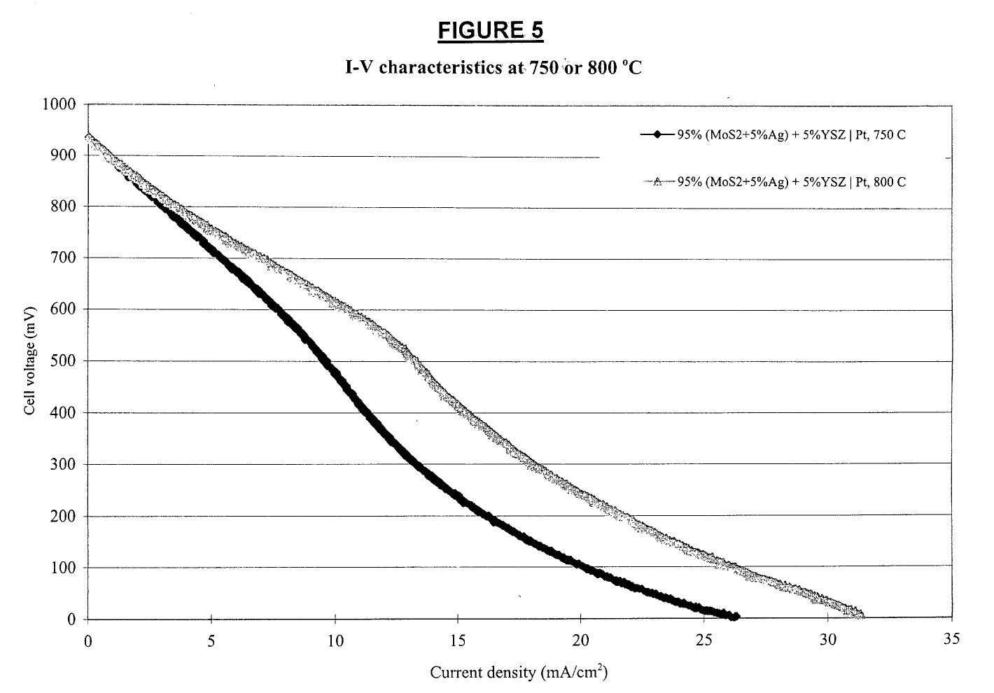

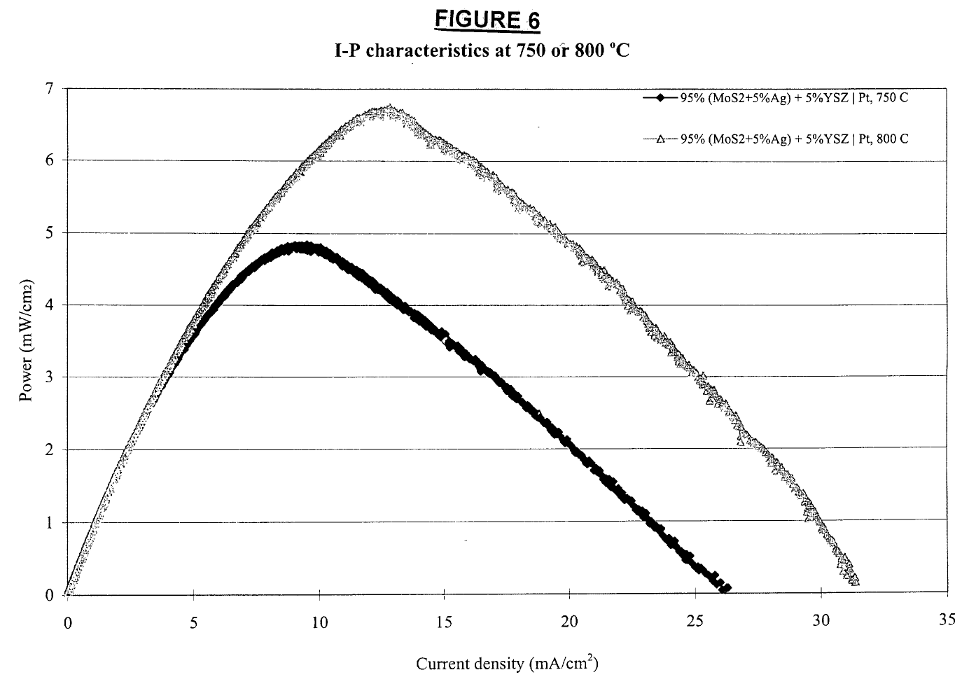

First MoS₂ and Ag were combined in a ratio of 95:5 (by weight) and then, mixed with YSZ (5% of final weight). The composite anode catalyst was combined with α-terpeniol to make a paste. The paste was applied to a YSZ disk. A graph of voltage as a function of current density for a fuel cell having this anode catalyst is shown in FIG. 5. A graph of power density versus current density is shown in FIG. 6.

### Example 4

(MOS₂+NiS)+Ag as Anode Catalyst

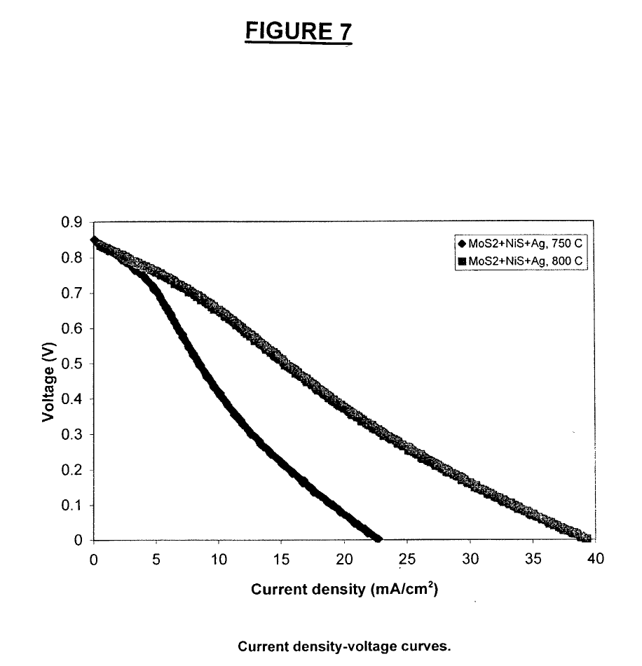

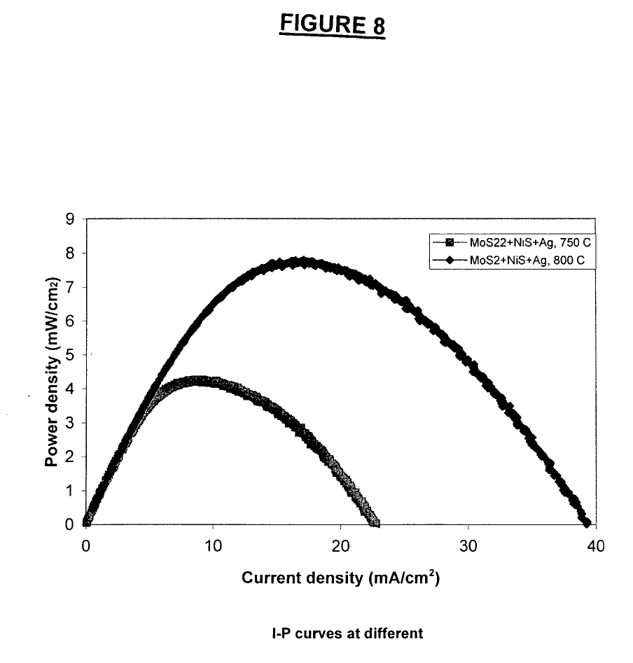

First MOS₂ and NiS were combined in a ratio of 1:1 (weight) and then mixed with Ag (5% of final weight). The composite anode catalyst was combined with α-terpeniol to make a paste. The paste was applied to a YSZ disk. A graph of voltage as a function of current density for a fuel cell having this anode catalyst is shown in FIG. 7. A graph of power density versus current density is shown in FIG. 8.

### Example 5

(MOS₂+NiS)+Ag+YSZ as Anode Catalyst

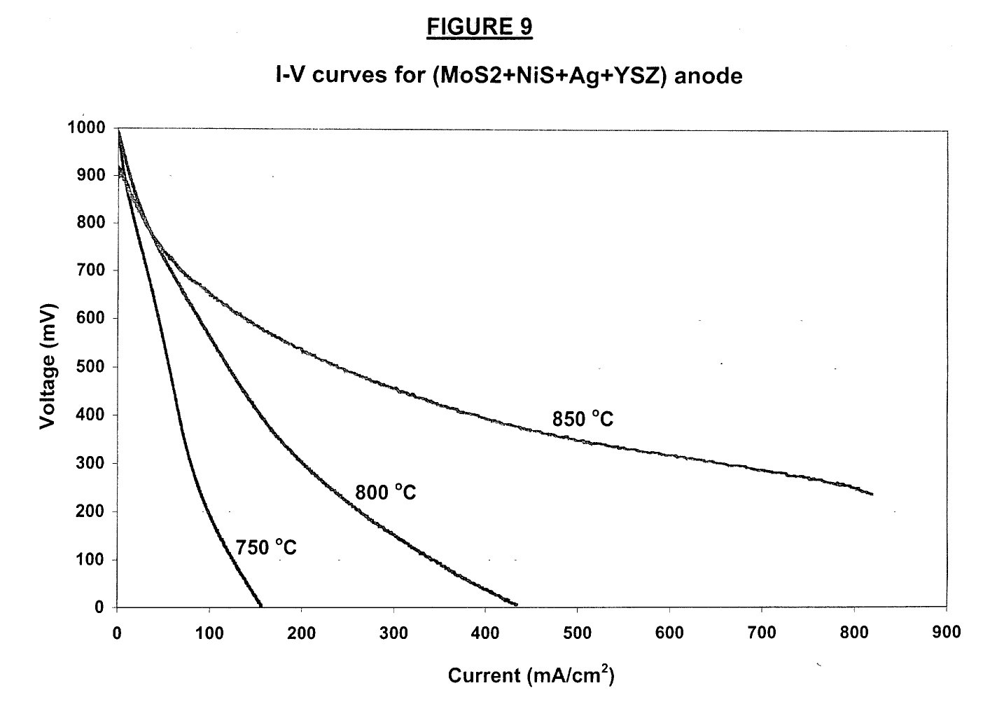

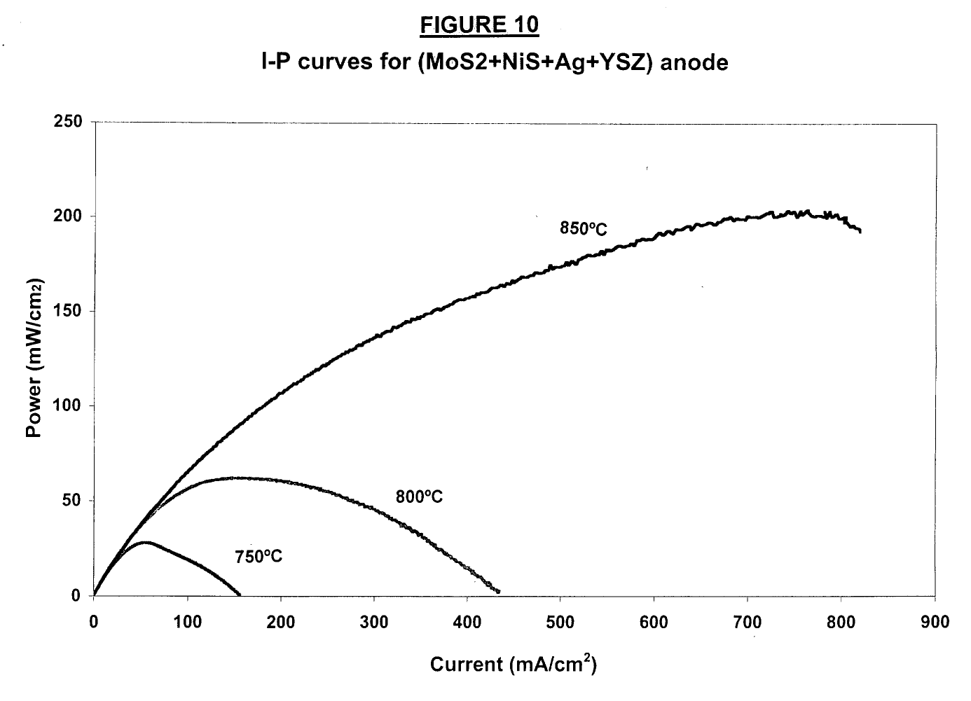

First MOS₂ and NiS were combined in a ratio of 1:1 (weight) and then mixed with Ag (to provide a ratio of MoS₂/NiS:Ag of 95:5), followed by YSZ (5% by weight of final product). The composite anode catalyst was combined with α-terpeniol to make a paste. The paste was applied to a YSZ disk. A graph of voltage as a function of current density for a fuel cell having this anode catalyst is shown in FIG. 9. A graph of power density versus current density is shown in FIG. 10.

Discussion for Examples 1-5

Power density is an important criterion in measuring cell performance. Values greater than about 100 mW/cm² indicate a potential commercially useful fuel cell. The peak power density for the anode catalyst of Example 5 was over 200 mW/cm², therefore this catalyst composition is an example of an anode catalyst that satisfies the need for an active anode catalyst. This power density value was obtained at 850° C., indicating that this catalyst is also useful for operating an electrolysis cell at temperatures above the vapour point of sulfur.

From the Examples provided above it can be seen that the use of the conducting material (compare Examples 1 and 2), the porous material (compare Examples 5 and 4) and a mixed metal sulfide (compare Examples 5 and 3) contribute to the significant improvement in the activity of the anode catalyst.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

Full Citations for References Referred to in the Specification

K. T. Chuang and A. R. Sanger, in Air Pollution, ed. D. H. F. Liu and B. G. Liptak, Lewis Publishers (division of CRC Press) Boca Raton (2000), Section 3.7, pp 154-180.

K. T. Chuang, A. R. Sanger, S. V. Slavov, and J. C. Donini, Int. J. Hydrogen Energy, 26, 103 (2001); and references therein.

J. C. Donini, K. T. Chuang, S. V. Slavov, A. R. Sanger, and V. Stanic, U.S. Pat. No. 6,241,871 (2001).

K. Kordesch and G. Simader, Fuel Cells and Their Applications, VCH, Weinheim (1996).

T. W. Kueper, S. J. Visco and L. c. De Jeonghe, Solid State Ionics, 52 (1992) 251.

M. Liu, P. He., J. L. Luo, A. R. Sanger, and K. T. Chuang, J. Power Sources, 94, 20 (2001).

T. J. Mazanec and T. L. Cable, U.S. Pat. No. 4,933,054 (1990).

J. N. Michaels and C. G. Vayenas, J. Catalysis, 85, 477-487 (1984).

T. Nakagaki, T. Ogawa, M. Hori, T. Hayashi, and T. Nishida, U.S. Pat. No. 6,099,983 (2000).

S. Petrovic, J. C. Donini, S. S. Thind, S. Tong and A. R. Sanger, U.S. Pat. No. 6,294,068 (2001).

A. F. Sammells, U.S. Pat. No. 4,544,461 (1985).

J. H. White, M. Schwarz, and A. F. Sammells, U.S. Pat. No. 6,281,403 (2001).

Z. D. Ziaka and S. Vasileiadis, U.S. Pat. No. 6,090,312 (2000).

We claim:

1. An anode catalyst composition for a gas phase H₂S—O₂ fuel cell having a proton-conducting membrane comprising:
(a) two or more metal sulfides of the formula MSₓ, wherein M is selected from the group consisting of Co, Ni, Fe, Mo, Cu, Cr, W and Mn, and x is between about 1.0 and about 2.5;
(b) a conductive material suitable for fuel cell operation; and
(c) a porous material,
wherein both of the conductive material and porous material are present in the composition in amounts up to about 10% by weight of the composition.

2. The catalyst composition according to claim 1, wherein M is selected from the group consisting of Co, Ni, Fe, Mo, W and Mn.

3. The catalyst composition according to claim 2, comprising two metal sulfides, wherein in one metal sulfide of the formula MSₓ, M is selected from the group consisting of Co, Ni and Fe and in the other metal sulfide of the formula MSₓ, M is selected from the group consisting of Mo and W.

4. The catalyst composition according to claim 3, wherein the two metal sulfides are NiS and MoS₂.

5. The catalyst composition according to claim 1, wherein the conductive material is selected the group consisting of:
(a) metals selected from silver, gold, nickel, bismuth, manganese, vanadium, platinum, rhodium, ruthenium, palladium, copper, zinc, cobalt, chromium and iron;
(b) oxides of the metals in (a);
(c) silver-bismuth oxide mixtures, tin-indium oxide mixtures, praeseodymium-indium oxide mixtures, cerium-lanthanum oxide mixtures; and
(d) mixtures of (a)-(c).

6. The catalyst composition according to claim 5, wherein the conductive material is silver.

7. The catalyst composition according to claim 1, wherein the porous material is selected from the group consisting of Y₂O₃-stabilized ZrO₂; Sc₂O₃-stabilized ZrO₂; Y₂O₃-stabilized Bi₂O₃; Y₂O₃-stabilized CeO₂; CaO-stabilized CeO₂; ThO₂; Y₂O₃-stabilized ThO₂; ThO₂, ZrO₂, Bi₂O, CeO₂ or HfO₂ stabilized by the addition of any one of the lanthanide oxides or CaO; and Al₂O₃

8. The catalyst composition according to claim 7, wherein the porous material is yttria-stabilized zirconia (YSZ).

9. The catalyst composition according to claim 1, wherein the ratio of metal sulfide:conductive material:porous material is about 90:5:5 by weight.

10. The catalyst composition according to claim 1, wherein the metal sulfides are present in about equivalent amounts by weight.

11. A method of preparing an anode catalyst composition for a gas phase H₂S—O₂ fuel cell having a proton-conducting membrane comprising:
(a) combining two or more sulfides of the formula MSₓ, wherein M is selected from the group consisting of Co, Ni, Fe, Mo, Cu, Cr, W and Mn and x is between about 1.0 and about 2.5, with a conductive material suitable for fuel cell operation; and
(b) combining the combination of (a) with a porous material,
wherein both of the conductive material and porous material are present in the composition in amounts up to about 10% by weight of the composition.

12. An electrolysis cell for the gas phase electrochemical oxidation of H₂S to sulfur and water or hydrogen comprising an anode chamber on one side of a proton-conducting membrane and a cathode chamber on the opposing side of the proton-conducting membrane, said anode chamber having an catalytic anode and said cathode chamber having a catalytic cathode wherein said anode comprises a catalyst composition according to claim 1.

13. An electrolysis cell for the gas phase electrochemical oxidation of H₂S to sulfur and water or hydrogen comprising an anode chamber on one side of a proton-conducting membrane and a cathode chamber on the opposing side of the proton-conducting membrane, said anode chamber having an catalytic anode and said cathode chamber having a catalytic cathode wherein said anode comprises a catalyst composition according to claim 3.

14. An electrolysis cell for the gas phase electrochemical oxidation of H₂S to sulfur and water or hydrogen comprising an anode chamber on one side of a proton-conducting membrane and a cathode chamber on the opposing side of the proton-conducting membrane, said anode chamber having an catalytic anode and said cathode chamber having a catalytic cathode wherein said anode comprises a catalyst composition according to claim 9.

15. A process for the gas phase electrochemical oxidation of H₂S to sulfur and water or hydrogen using an electrolysis cell having an anode chamber on one side of a solid proton conducting membrane and a cathode chamber on the opposing side of the membrane comprising:
(1) passing an H₂S-containing gas through the anode chamber to contact a catalytic anode, where it reacts to produce elemental sulfur, protons and electrons;
(2) passing protons through the membrane from the anode chamber to the cathode chamber; and
(3) either passing an oxygen-containing gas through the cathode chamber to contact the catalytic cathode, where it reacts with protons and electrons to produce water or steam, or forming hydrogen in the cathode chamber,
wherein said catalytic anode comprises a catalyst composition according to claim 1.

16. A process for the gas phase electrochemical oxidation of H₂S to sulfur and water or hydrogen using an electrolysis cell having an anode chamber on one side of a solid proton conducting membrane and a cathode chamber on the opposing side of the membrane comprising:
(1) passing an H₂S-containing gas through the anode chamber to contact a catalytic anode, where it reacts to produce elemental sulfur, protons and electrons;
(2) passing protons through the membrane from the anode chamber to the cathode chamber; and
(3) either passing an oxygen-containing gas through the cathode chamber to contact the catalytic cathode, where it reacts with protons and electrons to produce water or steam, or forming hydrogen in the cathode chamber,
wherein said catalytic anode comprises a catalyst composition according to claim 3.

17. A process for the gas phase electrochemical oxidation of H₂S to sulfur and water or hydrogen using an electrolysis cell having an anode chamber on one side of a solid proton conducting membrane and a cathode chamber on the opposing side of the membrane comprising:
(1) passing an H₂S-containing gas through the anode chamber to contact a catalytic anode, where it reacts to produce elemental sulfur, protons and electrons;
(2) passing protons through the membrane from the anode chamber to the cathode chamber; and
(3) either passing an oxygen-containing gas through the cathode chamber to contact the catalytic cathode, where it reacts with protons and electrons to produce water or steam, or forming hydrogen in the cathode chamber,
wherein said catalytic anode comprises a catalyst composition according to claim 9.

18. The process according to claim 15, wherein the cell is operated at a temperature above the vapour point of sulfur.

19. The process according to claim 15, wherein the cell is operated at a temperature in the range of about 700° C. to about 1000° C.

20. The process according to claim 15, wherein the cell is operated at a temperature in the range of about 750° C. to about 850° C.
